(19) United States
(12) Patent Application Publication
(10) Pub. No.: US 2007/0014241 A1
(43) Pub. Date: Jan. 18, 2007

(54) Resolver caching of a shortest path to a multihomed server as determined by a router

(76) Inventors: Dwip N. Banerjee, Austin, TX (US); Vasu Vallabhaneni, Austin, TX (US); Patrick T. Vo, Houston, TX (US)

Correspondence Address: IBM CORP (AP);C/O AMY PATTILLO, P. O. BOX 161327, AUSTIN, TX, 78716, US

(21) Appl. No.: 11/181,416

(22) Filed: Jul. 14, 2005

(51) Int. Cl. H04J 3/14; H04L 12/28

(52) U.S. Cl. 370/238; 370/351

(57) ABSTRACT

A resolver queries a DNS server for any network addresses associated with the particular domain name. If the resolver detects a response for the DNS server with multiple network addresses for a particular domain name, then the resolver creates and sends a shortest path query to at least one router enabled to receive and respond to shortest path queries. The shortest path query indicates at least one source address and the multiple destination addresses returned by the DNS server for the particular domain name. The router detects a separate length for each path accessible between each source address and each of the multiple destination addresses. The router then orders the destination addresses from shortest path to longest path and returns the ordered destination addresses to the requesting resolver. The resolver caches the ordered network addresses in the local cache in association with the particular domain name, such that for future requests for the particular domain name, the resolver retrieves from local cache the shortest path network address as ordered by the router. In addition, the resolver, responsive to receiving the ordered destination addresses, selects the shortest path network address for a response to an application requesting the resolution of the particular domain name.

### BACKGROUND OF THE INVENTION

1. Technical Field

The present invention relates in general to computer managed communication networks and, particularly, to a resolver enabled to query a router to sort the network addresses to indicate a shortest path from a client to a multihomed server and the resolver then caching the shortest path for future use.

2. Description of the Related Art

Within a computer managed communication network, such as the Internet, each computer system accessible via the network is typically identified by a network address. In the example of the Internet, Transmission Control Protocol/Internet Protocol (TCP/IP) controls the distribution of packets of information between computer systems, where each packet is directed from a system at one network address to a system at another network address. The network address, or IP address within the Internet, identifies a location of system within a network and may take the form of a numerical address, such as 165.55.128.60.

More user friendly networks, such as the Internet, may implement an address translation system, such as the Domain Name System (DNS), so that users may request access to other systems through a name based address rather than a numerical IP address. The DNS can be implemented through a separate network of computers distributed throughout, and connected to, the Internet. These computers that implement the DNS are commonly referred to as DNS servers. DNS servers store database tables of domain names corresponding to IP addresses. A user seeking to access a web page located at a particular server need only enter the domain name, such as “www.abc.com”, rather than the IP address of the server location, and the DNS server translates the domain name into the associated IP address and returns the IP address to the client system.

Some host systems, termed multihomed systems, are computers assigned to a particular domain name, but with multiple network connections. In one example, a multihomed system is one that is connected to two upstream service providers. In another example, a multihomed system is one that is connected to a single upstream service provider at multiple network addresses. In particular, a multihomed system may prove more reliable because if one service provider fails, the connection via the other service provider still enables the host to respond to requests.

A DNS server database table will include the multiple IP addresses for the multihomed system assigned to a particular domain name. The DNS server may return a single address or multiple addresses for the multihomed system responsive to a request for the IP address associated with the particular domain name. In addition, the DNS server may support some load balancing among the multiple addresses by alternating the addresses distributed or alternating the order in which addresses are distributed. For example, the IP addresses for a particular multihomed system include IN A 9.3.2.1 and IN A 9.4.2.1. The first time that a client queries the DNS server for the IP addresses for the multihomed system, the DNS server returns the addresses ordered as “9.3.2.1” and “9.4.2.1”. For load balancing, however, the second time that a same or different client queries the DNS server for the IP address for the multihomed server, the DNS server returns the addresses ordered as “9.4.2.1” and “9.3.2.1”.

A resolver performs the process of facilitating a client system query to a DNS server with a request for the IP address associated with a domain name. When the DNS server returns multiple IP addresses in response to a domain name query, the resolver typically passes the first listed IP address to the requesting application. One limitation of a resolver is that it is unaware of which address is the shortest path. Thus, while the addresses may happen to be ordered with the address that is the shortest path from the client to the server listed first, it is just as likely that the addresses are ordered so that the first address is the least efficient path; the unaware resolver will then pass the least efficient path address to the requesting application.

In addition, a resolver may use a cache for storing previously retrieved IP addresses in response to queries of a DNS server. For each future query, the resolver may first check the cache to see whether a response is already stored for the domain name from a previous DNS query, before querying the DNS server again. Where a query returns multiple addresses for a particular domain name, the resolver caches the responses in the order returned. Another limitation of a resolver is that when the first address cached is the least efficient path, the inefficiency is compounded because responses to the next series of requests for the same domain name will cause the resolver to automatically select that same inefficient path.

### SUMMARY OF THE INVENTION

Therefore, in view of the foregoing, the present invention provides a method, system, and program, for a resolver that responsive to receiving multiple network addresses assigned to a same domain name, queries a router to order the network addresses from shortest path to longest path from the client system, where the router is enabled to receive and respond to shortest path queries from resolvers. The resolver only caches the multiple network addresses as ordered by the router response.

In one embodiment, a resolver searches a local cache for a domain name, and responsive to the local cache returning empty of any valid network addresses for the domain name, the resolver queries a DNS server for any network addresses associated with the particular domain name. If the resolver detects a response for the DNS server with multiple network addresses for a particular domain name, then the resolver creates and sends a shortest path query to at least one router enabled to receive and respond to shortest path queries. The shortest path query indicates at least one source address and the multiple destination addresses returned by the DNS server for the particular domain name. The router detects a separate length for each path accessible between the source address and each of the multiple destination addresses. The router then orders the destination addresses from shortest path to longest path and returns the ordered destination addresses to the requesting resolver. The resolver caches the ordered network addresses in the local cache in association with the particular domain name, such that for future requests for the particular domain name, the resolver retrieves from local cache the shortest path network address as ordered by the router. In addition, the resolver, after receiving the ordered destination addresses, selects the shortest path network address for a response to the application requesting the resolution of the particular domain name.

A router enabled to receive and respond to shortest path queries implements a routing protocol to determine the topology of each path and calculate a length or cost for each path. The routing protocol may be one implemented by the router for detecting network topology and determining packet routing in normal routing operations. For example, the routing protocol may include at least one from among Routing Information Protocol, Open Shortest Path First, Border Gateway Protocol.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a block diagram depicting a computer system in which the present method, system, and program may be implemented;

FIG. 2 is a block diagram depicting a network environment for supporting server access;

FIG. 3 is a pictorial diagram depicting an example network topology of paths between a multihomed client system and a multihomed server;

FIG. 4 is a block diagram depicting one embodiment of a resolver application interacting with a DNS server and router within a network;

FIG. 5 is a flow diagram depicting an example of the flow of data between a resolver interacting with a DNS server and router;

FIG. 6 is a high level logic flowchart depicting a process and program for resolving a shortest path from a client system to a multihomed system and caching multiple paths in order of efficiency; and

FIG. 7 is a high level logic flowchart depicting a process and program for a shortest path query controller.

### DETAILED DESCRIPTION OF THE PREFERRED EMBODIMENT

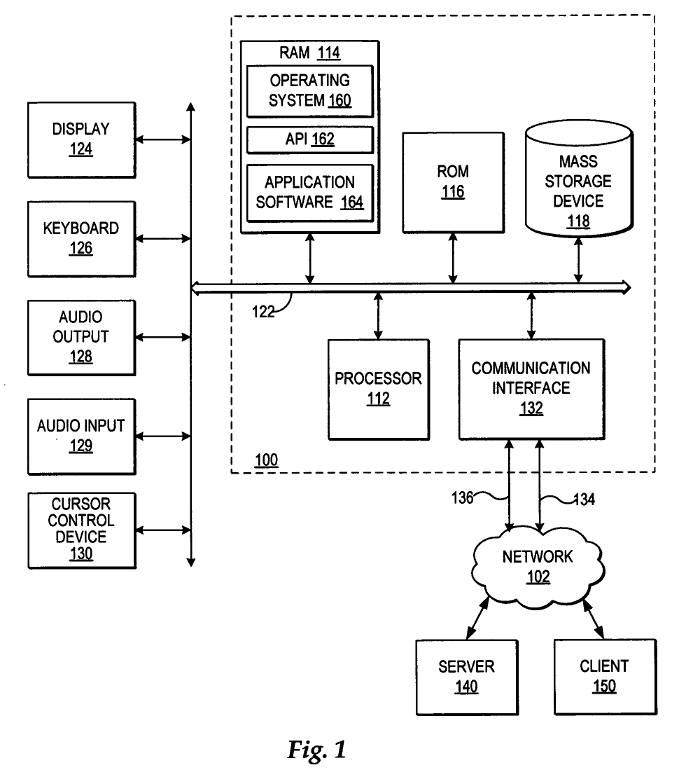

Referring now to the drawings and in particular to FIG. 1, there is depicted one embodiment of a computing system through which the present method, system, and program may be implemented. The invention may be executed in a variety of systems, including a variety of computing systems and electronic devices.

Computer system 100 includes a bus 122 or other communication device for communicating information within computer system 100, and at least one processing device such as processor 112, coupled to bus 122 for processing program code and data. Bus 122 may include low-latency and higher latency paths that are connected by bridges and adapters and controlled within computer system 100 by multiple bus controllers. Processor 112 may be a general-purpose processor such as IBM's PowerPC (PowerPC is a registered trademark of International Business Machines Corporation) processor. When implemented as a server system, computer system 100 typically includes multiple processors designed to improve network servicing power.

Processor 112 is coupled, directly or indirectly, through bus 122 to memory elements. During normal operation, processor 112 processes data under the control of program code accessed from the memory elements. Memory elements can include local memory employed during actual execution of the program code, such as random access memory (RAM) 114, bulk storage, such as mass storage device 118, and cache memories (not depicted) which provide temporary storage of at least some program code to reduce the number of times code must be retrieved from bulk storage during execution. In one example, the program code accessible in RAM 114 is an operating system 160 and application software 164. Operating system 160 includes program code that facilitates, for example, a graphical user interface (GUI) via a display 124 and other output interfaces.

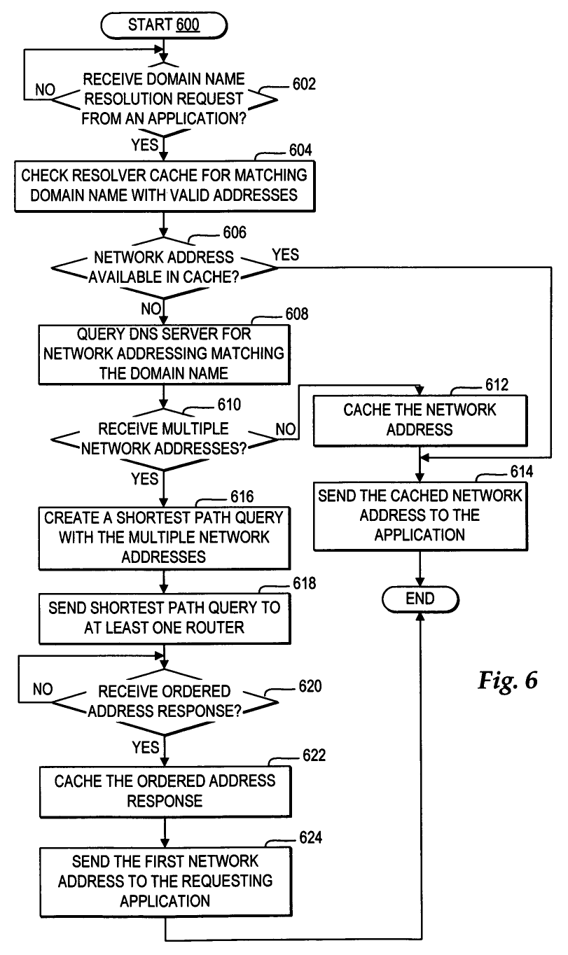

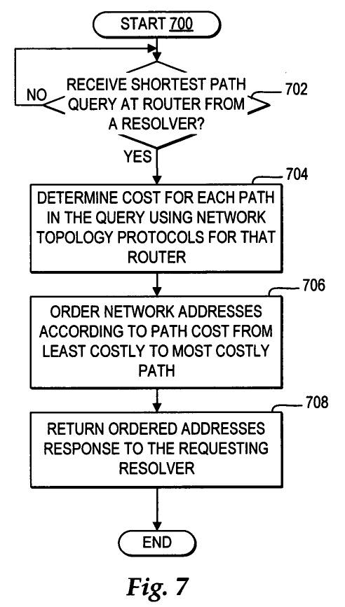

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc. For example, in one embodiment, operating system 160 and/or application software 164 contains program code that when executed on processor 112 carry out the operations depicted in the flow diagrams and flowcharts of FIGS. 6 and 7 and other operations described herein. Alternatively, the steps of the present invention might be performed by specific hardware components that contain hardwired logic for performing the steps, or by any combination of programmed computer components and custom hardware components. Additionally, RAM 114 may include an application programming interface (API) 162 or other interface that provides extensions to enable application developers to develop application software 164 that extend the functionality of operating system 160.

In addition, the invention can take the form of a computer program product accessible from a computer-usable or computer readable medium providing computer readable program code for use by or in connection with computer system 100 or any instruction execution system. For purposes of this description, a computer-usable or computer readable medium can be any apparatus that can contain, store, communicate, propagate, or transport the program for use by or in connection with the instruction execution system, apparatus, or device. In one example, a computer-usable or computer readable medium is any apparatus that participates in providing program code to processor 112 or other components of computer system 100 for execution.

Such a medium may take many forms including, but not limited to, electronic, magnetic, optical, electromagnetic, infrared, or semiconductor system (or apparatus or device) or a propagation medium. Examples of a computer readable medium include, but are not limited to, a semiconductor or solid state memory, magnetic tape, a flexible disk, a hard disk, a removable computer diskette, random access memory (RAM) 114, read-only memory (ROM) 116, punch cards or any other physical medium with patterns of holes, a rigid magnetic disk and an optical disk. Current examples of optical disks include a compact disc ROM (CD-ROM), a compact disc-read/write (CD-R/W) and a digital video disc (DVD). In another example, a computer readable medium may include mass storage device 118, which as depicted is an internal component of computer system 100, but may be provided as a device external to computer system 100.

A communication interface 132 including network adapters may also be coupled to the system to enable computer system 100 to become coupled to other computer systems, such as server 140 or client 150, remote printers, or storage devices through intervening private or public networks. Network adapters within communication interface 132 may include, but are not limited to, modems, cable modems, and Ethernet cards.

In particular, communication interface 132 enables coupling to other devices through at least one of network links 134 and 136 to a network 102. For example, a same or separate a local area network (LAN), wide area network (WAN), or an Internet Service Provider (ISP) may facilitate each of network links 134 and 136. Each of network links 134 and 136 is assigned to a particular local area network address, wide area network address, or IP network address. Network links 134 and 136 may provide wired and/or wireless network communications to one or more networks, such as network 102. Network 102 may refer to the worldwide collection of networks and gateways that use a particular protocol, such as Transmission Control Protocol (TCP) and Internet Protocol (IP), to communicate with one another.

Where computer system 100 includes multiple network links 134 and 136, each assigned to a different network address, computer system 100 is considered a multihome system. For purposes of description, a multihome system includes multiple network links facilitated by a single or multiple providers and networks. In addition, when implemented as a server system, computer system 100 typically includes multiple communication interfaces accessible via multiple peripheral component interconnect (PCI) bus bridges connected to an input/output controller. Each of network links 134 and 136 may be facilitated by a different communication interface.

In general, network links 134 and 136 and network 102 both use electrical, electromagnetic, or optical signals that carry digital data streams. The signals through the various networks and the signals on network links 134 and 136 and through communication interface 132, which carry the digital data to and from computer system 100, are examples of forms of carrier waves transporting the information. In one example, a remote computer, such as server 140 transfers the program code for the invention to requesting computer system 100 by way of data signals embodied in a carrier wave or other propagation medium via a network links 134 and 136 to a communications interface 132 coupled to bus 122.

In addition, computer system 100 typically includes multiple peripheral components (e.g. input/output devices) that facilitate communication. These peripheral components are coupled to computer system 100 either directly or indirectly through connections to multiple input/output (I/O) controllers, adapters, and expansion slots coupled to one of the multiple levels of bus 122. For example, an audio output device 128 and audio input device 129 are connectively enabled on bus 122 for controlling audio outputs and inputs. A display device 124 is also connectively enabled on bus 122 for providing visual, tactile or other graphical representation formats and a cursor control device 130 is connectively enabled on bus 122 for controlling the location of a pointer within display device 124. A keyboard 126 is connectively enabled on bus 122 as an interface for user inputs to computer system 100. In alternate embodiments of the present invention, additional input and output peripheral components may be added.

Those of ordinary skill in the art will appreciate that the hardware depicted in FIG. 1 may vary. Furthermore, those of ordinary skill in the art will appreciate that the depicted example is not meant to imply architectural limitations with respect to the present invention.

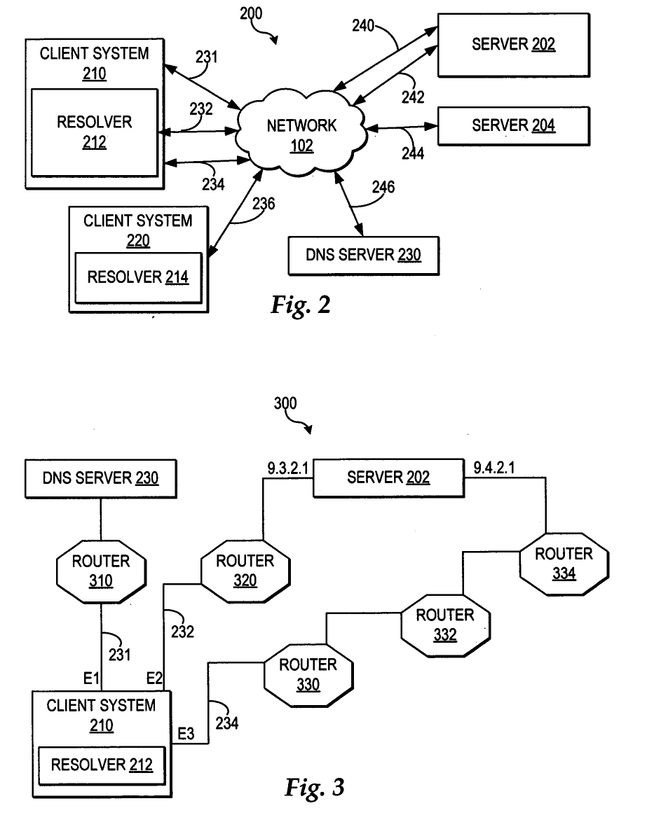

With reference now to FIG. 2, a block diagram depicts a network environment for supporting server access in accordance with the method, system, and program of the present invention. As illustrated, a distributed network 200 is a network of multiple computer systems such as client system 210, client system 220, server 202, server 204 and DNS server 230, through which data is accessed and downloaded. In alternate embodiments, distributed network 200 may include other embodiments of computing systems enabled to communicate with one another via a connection. Although not depicted in FIG. 2, following the description of computing system 100, in general, each of client system 210, client system 220, server 202, server 204 and DNS server 230 includes at least one processor and memory for supporting program code which may include an operating system, APIs, and application programs. In addition, server 202, server 204, DNS server 230, and other systems that perform server functions may include middleware applications loaded into memory that support server functions, where the middleware applications may include, for example, IBM's Websphere or NetFinity (Websphere and NetFinity are registered trademarks of International Business Machines Corporation).

In the embodiment, distributed network 200 includes network 102, which is the medium used to provide communications links between various devices and computers connected together within distributed network 200. Network 102 may include permanent connections such as wire or fiber optics cables and temporary connections made through telephone connections and wireless transmission connections, for example.

In particular, in the embodiment, distributed network 200 includes at least one server, such as servers 202 and 204, and at least one client, such as client systems 210 and 220, communicatively connected via network 102. In addition, distributed network 200 may include at least one Domain Name System (DNS) server, such as DNS server 230, for implementing the Domain Name System or other address translation service. It will be understood that each of web servers 202 and 204, DNS server 230, and client systems 210 and 220 may be distributed in geographically disparate locations throughout heterogeneous types of computer systems operating within disparate local networks. In addition, it will be understood that web servers 202 and 204 and DNS server 230 may represent a single server system, a cluster of server systems, a grid of server systems, or other combination of systems providing access to a particular web page or multiple web pages. In addition, it will be understood that distributed network 200 may include additional servers, clients, and other devices not shown.

Servers 202 and 204, DNS server 230 and client systems 210 and 220 may communicate within distributed network 200 in conformance with different network environment architectures. In the embodiment depicted, distributed network 200 conforms to a client/server network architecture where servers 202 and 204 perform as servers for providing services and data to client system 210 and client system 220 responsive to requests for services or data from client system 210 and client system 220. In facilitating the client/server environment, in one example, network 102 represents the worldwide collection of networks and gateways that use the TCP/IP suite of protocols to communicate with one another. In another example, network 102 is implemented as an intranet, a local area network (LAN), or a wide area network (WAN). It will be understood that distributed network 200 may conform to other network environments or a combination of multiple types of network environments. Further, it will be understood that in the client/server environment, any of client systems 210 and 220 may perform as a “server” if providing web services to another computer system via network 102. Additionally, it will be understood that distributed network 200 may support peer-to-peer network communications between client system 210 and client system 220, where one client system distributes a web page to another client system.

Each of servers 202 and 204, DNS server 230, and client systems 210 and 220 may enable connection with network 102 via a single or multiple independent network connections. For example, client system 210 is a multihomed system enabled with connections 231, 232, and 234 and server 202 is a multihomed system enabled with connections 240 and 242. Each connection resides at a different network address hosted by a same or different network provider. Client system 220, server 404 and DNS server 230 are depicted with single connections 236, 244, and 246, respectively, however, it will be understood that any of these systems may also be multihomed, with multiple separate connections to network 102.

To facilitate a more dynamic Internet, DNS server 230 maintains a database of server domain names and corresponding network IP addresses. DNS server 230 responds to requests from client systems for the IP addresses associated with a domain name by determining whether the database includes a listing for the domain name; if DNS server 230 is not able to locally translate the domain name address, DNS server 230 may transfer the domain name resolution request to other DNS servers with other translation tables.

As new systems are added to the Internet, DNS server 230 is updated with the domain name and IP address for each system. In addition, as new connections are added to a new or existing system, to enable a multihomed system, DNS server 230 is updated with the additional IP addresses for the domain name associated with the multihomed system. In the example, where server 202 is enabled with connections 240 and 242, DNS server 230 associates each of the separate IP addresses for connections 240 and 242 with a single domain name assigned to server 202. Server 204 is depicted with a single connection, however, as additional connections are added to server 204, DNS server 230 would be updated with the new IP address for the domain name associated with server 204.

DNS server 230 receives requests for the IP addresses associated with a domain name from resolvers. In the example, client systems 210 and 220 include resolvers 212 and 214, respectively, that handle communication between client systems 210 and 220 and DNS server 230. In particular, when an application or operating system needs the IP address for a particular server, identified by a domain name or other address, the application or operating system passes the domain name to a resolver. The resolver determines which DNS server, such as DNS server 230, to pass the domain name with a request for resolution of the associated IP address. The resolver will receive an IP address or addresses in response to the resolution request, if DNS server 230 can locate an IP address matching the domain name address, or will receive an error message indicating a lack of matching IP address or domain name registration.

In general, the resolver passes the IP address or error to the requesting application or operating system, such as a web browser, and the requesting application then sends a communication request to the IP address or controls output of an error message to the user. However, when DNS server 230 returns multiple IP addresses for a particular domain name, indicating a multihomed system, the resolver must select one of the addresses to pass to the application.

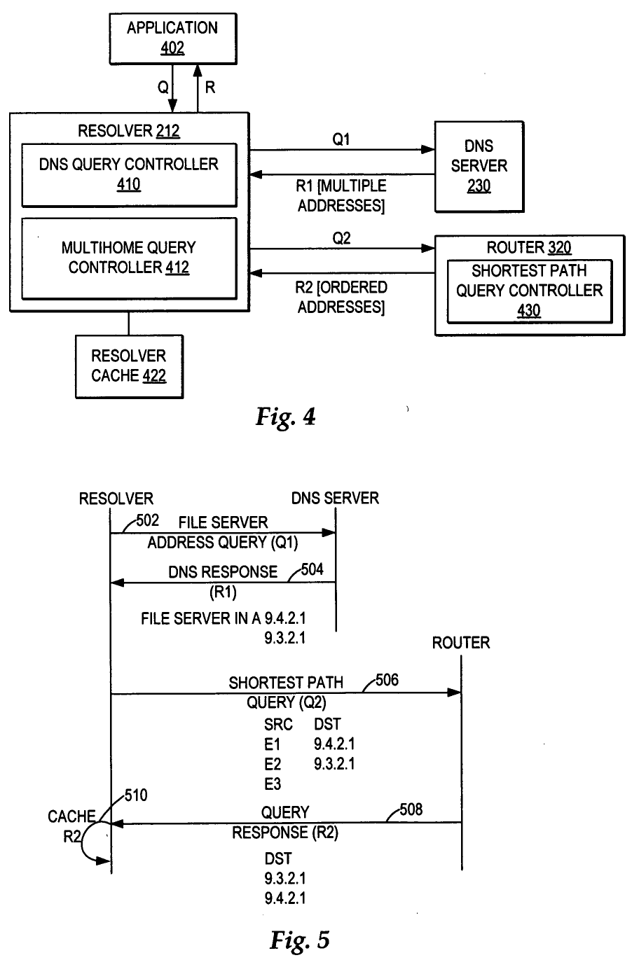

Although not depicted in FIG. 2, the path between a client and a server, such as the path between client system 210 and server 202, includes routers and network links. Further, with a multihomed client or server, such as client system 210 and server 202, there are potentially multiple available paths between the client and server, where each path has an associated cost or other factor indicating the time and resources, such as routers, designated for a path. According to an advantage, as will be described with reference to FIGS. 4, 5, and 6, before a resolver passes a particular one of the multihomed system IP addresses to a requesting application, the resolver may determine, from a router, the shortest path from among the available paths from the requesting client system to the multihomed system and pass the IP address for the shortest path. As will be further described, a resolver is program code that may be incorporated within operating system 160, application software 164, or both. Further, a resolver may reside in a system separate from the requesting system.

With reference now to FIG. 3, a pictorial diagram illustrates an example network topology of paths between a multihomed client system and a multihomed server. As illustrated, a topology 300 indicates the paths between multihomed client system 210 and DNS server 230 and multihomed server 202, accessible via network 102. In the example, client system 210 includes a connection 231 from a source address “E1” to DNS server 230 through router 310. In addition, in the example, client system 210 includes a connection 232 from a source address “E2” via router 320 to a server 202 at destination network address “9.3.2.1” and a connection 234 from a source address “E3” via routers 330, 332, and 334 to server 202 at destination network address “9.4.2.1”.

In the example, a request from client system 210 to DNS server 230 for the network addresses assigned to multihomed server 202 would return the network addresses “9.3.2.1” and “9.4.2.1”, in an order selected by DNS server 230. As illustrated, the path from client system 210 to network address “9.3.2.1” of server 202 is the shortest path with only router 320, when compared with the path to network address “9.4.2.1” with routers 330, 332, and 334. In particular, in addition to comparing the number of routers along a path to determine the shorter path, the characteristics of other network hardware and software along a path may be compared to determine a shortest or fast path. Further, the routing protocol used to determine each path may specify the network hardware and software characteristics used in calculating a shortest path.

Referring now to FIG. 4, a block diagram illustrates one embodiment of a resolver application interacting with a DNS server and router within a network. For purposes of illustration, the interaction of resolver 212 interacting with DNS server 230 and router 320 to resolve the network addresses of a multihomed server system is described. It will be understood that in other embodiments, other resolvers may interact with other DNS or translation servers and other routers. Further, it will be understood that resolver 212 may also interact with DNS server 230 to also resolve the network address of a server system with a single network address.

In the example, an application 402 passes a query Q for domain name resolution to resolver 212. Application 402 may represent a stand-alone application, an applet, an operating system, or other program code requiring the translation of a domain name into a network address for a particular client system.

A query controller 410 of resolver 212 detects the query Q and determines whether resolver cache 422 already includes the network addresses translated for the domain name in the query Q. If the network addresses translated for the domain name are already in resolver cache 422, then query controller 410 may determine whether the addresses are valid. In particular, each resolver may follow particular rules for maintaining valid addresses, such as automatically marking invalid those network addresses resident in resolver cache 422 longer than a designated time period. It will be understood that query controller 410 may also apply other rules or processes for determining the validity of network address in resolver cache 422. If resolver cache 422 includes valid network address for the domain name query, then query controller 410 selects the shortest path address as indicated by the caching order of the network addresses and returns the shortest path address in a response R to application 402.

Otherwise, if query controller 410 determines that no valid addresses for the domain name are in resolver cache 422, query controller 410 sends a resolution request query Q1 for the domain name to DNS server 230. DNS server 230 returns a response R1 with multiple addresses, indicating the multiple network addresses of the multihomed server system.

Multihome query controller 412 of resolver 212 detects R1 with multiple addresses and creates a shortest path query Q2 using a protocol accepted by router 320 and passes Q2 to router 320. In one example, a shortest path query uses a protocol that indicates the possible source address listed under “SRC” and the possible destination address listed under “DST”. In addition to creating the shortest path query, multihome query controller 412 may block query controller 410 from caching the network addresses returned as R1 or query controller 410 would detect that R1 includes multiple network addresses and pass R1 to multihome query controller 412, prior to selecting a particular address to return to application 402 as R.

Router 320 is enabled to receive and respond to shortest path queries through a shortest path query controller 430. In particular, router 320 supports at least one routing protocol that enables router 320 to determine the network topology, such as topology 300, including a determination of the cost of paths. For example, router 320 may support routing protocols including, but not limited to, Routing Information Protocol (RIP), RIP-2, Open Shortest Path First (OSPF), and Border Gateway Protocol (BGP), that enable router 320 to communicate with other routers to determine the network topology between the source address “SRC” and destination addresses “DST” included in a shortest path query.

Shortest path query controller 430 detects the path cost from each source address to each destination address, compares the path costs, orders the destination addresses to indicate the shortest path to the longest path, and returns the ordered addresses in a response R2. In an alternate embodiment, shortest path query controller 430 may order the destination addresses from longest path to shortest path and may order the source addresses with destination addresses. Further, shortest path query controller 430 may label destination addresses or include other indications of path cost that are passed to resolver 212 in R2, for use by resolver 212 or application 402.

When multihome query controller 412 detects ordered addresses response R2, multihome query controller 412 may then cache the response in resolver cache 422. In addition, multihome query controller 412 passes the shortest path address to query controller 410 to send in a response R to application 402. In a future request for the same domain name associated with the cached ordered addresses, query controller 410 accesses a shortest path address by accessing the first ordered address or address indicates as the shortest path associated with the domain name in resolver cache 422. It is important to note that prior to caching ordered addresses response R2, multihome query controller 412 may convert the ordered addresses response R2 so that the first listed address is the shortest path address or convert ordered addresses response E2 using other ordering conventions understood by query controller 410 if router 320 uses a different ordering convention from query controller 410.

It is important to note that multihome query controller 412 may first query a selection of routers to determine which routers are enabled to receive and respond to shortest path queries. In addition, it is important to note that while the present example, multihome query controller 412 passes the shortest path query to router 320, in the example of topology 300 of FIG. 3, multihome query controller 412 may also pass the shortest path query to routers 310 and 330. Further multihome query controller 412 may pass a particular shortest path query to a single or multiple routers and may concurrently pass multiple distinct shortest path queries to a single or multiple router, where each shortest path query is uniquely identifiable.

It will be understood that in an alternate embodiment, query controller 410 and multihome query controller 412 may be combined into a single functional component. Further, it will be understood that multihome query controller 412 may be integrated into an existing resolver application and that shortest path query controller 430 may be integrated into an existing router.

With reference now to FIG. 5, a flow diagram illustrates an example of the flow of data between a resolver interacting with a DNS server and router. In the example, a first query Q1 for the network address of server 202, as illustrated at reference numeral 502, passes from resolver 212 to DNS server 230. DNS server 230 passes a first response R1, as illustrated at reference numeral 504, with the network addresses reading as:

| | |
|---|---|
| FILE SERVER IN A | 9.4.2.1 |
| | 9.3.2.1 |

Resolver 212 creates a shortest path query Q2 in a shortest path protocol and passes the query to router 320, as illustrated at reference numeral 506. In the example, the query Q2 reads as:

| SRC | DST |
|---|---|
| E1 | 9.4.2.1 |
| E2 | 9.3.2.1 |
| E3 | |

In particular, resolver 212 includes the connection links E1, E2, and E3 as the possible source connections and includes the network addresses 9.4.2.1 and 9.3.2.1 as the possible destination addresses in the shortest path query. Router 320 determines the availability and cost associated with each possible between each SRC listing and each DST listing and returns a query response R2, as illustrated at reference numeral 508. In the example, the query response R2 reads as:

DST
9.3.2.1
9.4.2.1

In particular, the network addresses in the query response R2 are ordered from shortest path to longest path. Next, resolver 212 caches the query response R2 from router 320, as indicated at reference numeral 510. Advantageously, by caching the query response R2 from router 320, resolver 212 caches the network addresses for a multihomed server system ordered from shortest path to longest path from the particular client system to the multihomed server system.

With reference now to FIG. 6, a high level logic flowchart depicts a process and program for resolving a shortest path from a client system to a multihomed system and caching multiple paths in order of efficiency. As illustrated, the process or program starts at block 600 and thereafter proceeds to block 602. Block 602 depicts a resolver receiving a resolution request for a domain name from an application. If the resolver receives a resolution request for a domain name from an application, then the process passes to block 604. Block 604 illustrates the resolver checking the resolver cache for a matching domain name with valid addresses, and the process passes to block 606. Although not depicted, the resolver may include a process for predicting or monitoring the validity of cached network addresses.

Block 606 depicts the resolver determining whether a matching valid network address is available from the resolver cache. If a matching valid network address is available from the resolver cache, then the process passes to block 614. Block 614 illustrates sending the cached network address to the application, and the process ends. Although not depicted, if multiple network addresses are cached for the domain name, then the resolver returns the first network address or the address indicated by a router as the shortest path address. If an access to the first network address by the application returns an error, then the resolver may return the next network address and continue to return addresses until the application is able to access the multihomed system or all addresses indicate an error.

Returning to block 606, if a matching valid network address is not available from the resolver cache, then the process passes to block 608. Block 608 depicts querying the DNS server for the network addressing matching the requested domain name. Next, block 610 illustrates a determination by the resolver whether the DNS server returns multiple network addresses responsive to the query. If the DNS server only returns a single address, then the process passes to block 612. Block 612 illustrates caching the network address, and the process passes to block 614. Otherwise, at block 610 if the DNS server returns multiple addresses for a particular domain name, then the process passes to block 616.

Block 616 depicts creating a shortest path query with the multiple network addresses and router paths accessible to the client system according to the shortest path query protocol understood by a particular router. Next, block 618 illustrates sending the shortest path query to at least one router, where the at least one router is enabled to receive shortest path queries from resolvers. Thereafter, block 620 depicts a determination whether the resolver receives an ordered address response. Once the resolver receives an ordered address response, the process passes to block 622. Block 622 depicts caching the ordered address response. Next, block 624 illustrates sending the first network address to the requesting application, or the network address indicated otherwise by the router as the shortest path network address, and the process ends. Although not depicted, at block 620, if the resolver does not receive an ordered address response, then the resolver may cache the responses as ordered by the DNS server, and the process passes to block 624.

Referring now to FIG. 7, a high level logic flowchart depicts a process and program for a shortest path query controller. As illustrated, the process or program starts at block 700 and thereafter proceeds to block 702. Block 702 depicts a shortest path query controller of a router detecting a shortest path query received at the router from a resolver. If a shortest path query controller detects the shortest path query, then the process passes to block 704. Block 704 illustrates determining the cost for each path in the query using the network topology protocols accessible to the router. Next, block 706 depicts ordering the destination network addresses according to path cost from least costly to most costly. Thereafter, block 708 illustrates returning the ordered addresses response to the requesting resolver, and the process ends.

While the invention has been particularly shown and described with reference to a preferred embodiment, it will be understood by those skilled in the art that various changes in form and detail may be made therein without departing from the spirit and scope of the invention.

What is claimed is:

1. A system for caching a shortest path from a client system to a multihomed server, comprising:
a resolver for querying a domain name server for any network addresses associated with a particular domain name;
said resolver, responsive to detecting said domain name server return a plurality of network addresses responsive to said query for said particular domain name, for sending a shortest path query to at least one router, wherein said shortest path query specifies at least one source addresses and said plurality of network addresses;
said router for detecting a separate length for each path accessible between said at least one source address and each of said plurality of network address;
said router for ordering said plurality of network addresses to indicate a shortest path to a longest path and sending said ordered plurality of network addresses to said resolver; and
said resolver for caching said ordered plurality of network addresses in association with said particular domain name in a cache local to said resolver, wherein responsive to a next request for said particular domain name said resolver retrieves from said local cache a particular network address from among said plurality of addresses previously indicated by said router as said shortest path.

2. The system according to claim 1, said resolver for searching said local cache for said particular domain name and only querying said domain name server with said particular domain name responsive to said local cache returning empty of any valid network addresses associated with said particular domain name.

3. The system according to claim 1, further comprising:
an application for sending a request to said resolver for said particular domain name; and
said resolver, responsive to receiving said ordered plurality of network addresses, for returning to said application said particular network addressed indicated by said router as said shortest path.

4. The system according to claim 1, further comprising:
an application for sending a request to said resolver for said particular domain name; and
said resolver for specifying said at least one source address from at least one particular network address accessible to said application at a client system.

5. The system according to claim 1, said router enabled to receive and respond to said shortest path query.

6. The system according to claim 1, said router for detecting each said separate length for each path through at least one router protocol also implemented by said router for detecting a network topology and determining packet routing.

7. The system according to claim 5, wherein said at least one router protocol is at least one from among Routing Information Protocol, Open Shortest Path First, and Border Gateway Protocol.

8. The system according to claim 1, said resolver for converting said ordered plurality of network addresses from a first ordering protocol used by said router to a second ordering protocol used by said resolver prior to caching said plurality of network addresses ordered according to said second ordering protocol in said local cache.

9. A method for caching, in a cache associated with a resolver executing on at least one computer system, a shortest path from a client system to a multihomed server, comprising:
querying, from said resolver, a domain name server for any network addresses associated with a particular domain name;
responsive to detecting said domain name server return a plurality of network addresses, sending a shortest path query from said resolver to at least one router, wherein said shortest path query specifies at least one source addresses and said plurality of network addresses;
detecting, at said router, a separate length for each path accessible between said at least one source address and each of said plurality of network address;
ordering, at said router, said plurality of network addresses to indicate a shortest path to a longest path and sending said ordered plurality of network addresses to said resolver; and
responsive to said resolver receiving said ordered plurality of network addresses, caching said ordered plurality of network addresses in association with said particular domain name in said cache, wherein responsive to a next request for said particular domain name said resolver retrieves from said cache a particular network address from among said plurality of addresses previously indicated by said router as said shortest path.

10. The method according to claim 9, further comprising:
searching, by said resolver, said cache for said particular domain name; and
only querying said domain name server with said particular domain name responsive to said cache returning empty of any valid network addresses associated with said particular domain name.

11. The method according to claim 9, further comprising:
sending, from an application, a request to said resolver for resolution of said particular domain name; and
responsive to receiving said ordered plurality of network addresses at said resolver, returning from said resolver to said application said particular network addressed indicated by said router as said shortest path.

12. The method according to claim 9, further comprising:
sending, from an application, a request to said resolver for resolution of said particular domain name; and
specifying, by said resolver in said shortest path query, said at least one source address from at least one particular network address accessible to said application at a client system.

13. The method according to claim 9, wherein said router is enabled to receive and respond to said shortest path query.

14. The method according to claim 9, further comprising:
detecting, at said router, each said separate length for each path through at least one router protocol also implemented by said router for detecting a network topology and determining packet routing.

15. The method according to claim 14, wherein said at least one router protocol is at least one from among Routing Information Protocol, Open Shortest Path First, and Border Gateway Protocol.

16. The method according to claim 9, further comprising:
converting, at said resolver, said ordered plurality of network addresses from a first ordering protocol used by said router to a second ordering protocol used by said resolver prior to caching said plurality of network addresses ordered according to said second ordering protocol in said cache.

17. A program for offering an alternative product package offer comprising a computer readable medium including a computer readable program, wherein the computer readable program when executed on a computer causes the computer to:
query a domain name server for any network addresses associated with a particular domain name;
responsive to detecting said domain name server return a plurality of network addresses, send a shortest path query to at least one router, wherein said shortest path query specifies at least one source addresses and said plurality of network addresses, wherein said router is enabled to receive said shortest path query, detect a separate length for each path accessible between said at least one source address and each of said plurality of network addresses and return said plurality of network addressed ordered to indicate a shortest path to a longest path; and
responsive to receiving said ordered plurality of network addresses, cache said ordered plurality of network addresses in association with said particular domain name in a local cache, wherein responsive to a next request for said particular domain name said particular network address from among said plurality of addresses previously indicated by said router as said shortest path is retrieved from said cache.

18. The program according to claim 17, wherein the computer readable program when executed on a computer causes the computer to:
search said cache for said particular domain name; and
only query said domain name server with said particular domain name responsive to said cache returning empty of any valid network addresses associated with said particular domain name.

19. The program according to claim 17, wherein the computer readable program when executed on a computer causes the computer to:
receive a request for resolution of said particular domain name from a particular application; and
responsive to receiving said ordered plurality of network addresses, respond to said application with said particular network addressed indicated by said router as said shortest path.

20. The program according to claim 17, wherein the computer readable program when executed on a computer causes the computer to:
convert said ordered plurality of network addresses from a first ordering protocol used by said router to a second ordering protocol used by said computer readable program prior to caching said plurality of network addresses ordered according to said second ordering protocol in said cache.
